(19) United States
(12) Patent Application Publication
(10) Pub. No.: US 2005/0185044 A1
(43) Pub. Date: Aug. 25, 2005

(54) Method and system for recording images

(75) Inventor: Yoshiharu Sasaki, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/033,975

(22) Filed: Jan. 13, 2005

(30) Foreign Application Priority Data
Jan. 13, 2004 (JP) 005685/2004

(51) Int. Cl. B41J 2/355

(52) U.S. Cl. 347/239

(57) ABSTRACT

Binary image data representing a desired image is first generated, and on-off control of an energy beam scanning a recording medium is performed based on a value of each pixel data constituting the binary image data to record the image on the recording medium. Some pixel data are then selected from pixel data of the binary image data that have a first value turning on the energy beam, and the first value of the some pixel data is replaced with a second value turning off the energy beam. The on-off control is performed based on the first or second value of each pixel data constituting binary image data obtained after the first value is replaced with the second value.

### BACKGROUND OF THE INVENTION

1. Field of the Invention

The present invention relates to a method and system for recording patterns, such as characters, figures, etc., on a recording medium by scanning laser light, etc.

2. Description of the Related Art

There is known in the image recording art a system which irradiates laser light modulated with a spatial light modulator to a photosensitive recording medium to record images (e.g., see Japanese Unexamined Patent Publication No. 2003-345030). Also known in the prior art is a system which selectively applies a voltage to linearly arranged exothermic resistance elements to record images on a photosensitive recording medium. In these systems, binary image data representing an image is first generated or acquired. Then, an energy beam, such as light, heat, etc., which scans a recording medium is turned on-and-off based on a value of each pixel data constituting the binary image data.

For example, the system disclosed in the aforementioned Japanese Unexamined Patent Publication No. 2003-345030 is an exposure system employing a digital micro mirror device (hereinafter referred to as DMD (Texas Instruments)), in which a great number (e.g., 1024×768) of micro mirrors that each constitute 1 pixel are arrayed in the form of a lattice, as a spatial light modulator. In this system, the direction of each micro mirror is individually controlled based on the value of each pixel data constituting binary image data, and laser light incident on each micro mirror is reflected in one of two directions. The laser light reflected in one direction of the two directions is passed through an optics system and recorded on a recording medium. That is, laser light reflected by micro mirrors corresponding to pixels having a value of 1 is imaged onto the recording medium. In this manner, a desired image can be recorded.

It is known that the above-described image recording systems are utilized in the fabrication of printed circuit boards. Typically, printed circuit boards are fabricated as follows. First, a resist layer comprising a photosensitive material is formed on a conductive layer (e.g., a thin film of Cu) to form wiring patterns. Then, the resist layer is exposed by using the same patterns of shapes as the wiring patterns. After the same patterns of shapes as the wiring patterns (hereinafter referred to as resist patterns) are formed in the resist layer by development, the conductive layer is etched with the resist patterns as a mask. In this manner, wiring patterns are formed on the conductive layer.

The exposure of a resist layer has hitherto been performed by bringing a mask film with openings of the same shapes as wiring patterns into direct contact with the resist layer. However, if the above-described image recording systems are employed, resist patterns can be recorded (or exposed) directly on the resist layer.

In the fabrication of printed circuit boards, the following problems are typically known. When fabricating double-sided (or multilayer) printed circuit boards, a through hole for connecting wirings is first formed in each surface and then wiring patterns are formed on each surface. At this stage, the resist layer formed on the through hole is inferior to other parts in mechanical strength, so resist patterns are sometimes damaged in the aforementioned development and etching processes. To cope with this problem, a photosensitive resin compound with enough mechanical strength to endure spray pressure such as an etching solution is shown in Japanese Unexamined Patent Publication No. 10(1998)-142789, for example.

As a substitute method for the method disclosed in the aforementioned Japanese Unexamined Patent Publication No. 10 (1998)-142789, the inventors have made various investigations with respect to a method of fabricating a printed circuit board by employing a resist film comprising different kinds of photosensitive (or heat-sensitive) materials different in sensitivity, as described in detail later. More specifically, a two-layer resist film, consisting of a thin-film highly-sensitive layer sensitive to even a relatively low irradiation energy and a thick-film low-sensitive layer sensitive to a high irradiation energy, is formed on a conductive layer. For instance, for a line portion of a wiring pattern that requires high resolution, a resist pattern consisting of only a thin-film highly-sensitive layer is formed. For a through-hole periphery of the wiring pattern that requires a mechanical strength, a resist pattern consisting of a thin-film highly-sensitive layer and a thick-film low-sensitive layer is formed.

The above-described resist patterns are formed as follows. That is, when recording (or exposing) an image representing the line portion in the resist layer, a low energy is irradiated so the image is recorded in only the thin-film highly-sensitive layer. On the other hand, when recording an image representing the land portion of the through-hole periphery, a high energy is irradiated so the image is recorded in both the thick-film low-sensitive layer and the thin-film highly-sensitive layer. If development is performed after different images are respectively recorded in the different layers, a resist pattern including a 1-layer structure and a 2-layer structure together can be formed.

However, since it takes time for laser light to become stable, it is fairly difficult to perform exposure while suitably changing the intensity of laser light. For that reason, two or more scanning operations become necessary to irradiate laser light of different levels to the regions of the resist layer, respectively. The amount of the time needed to record resist patterns is two times or more of that of the conventional method, so it is difficult to put this method to practical use from the standpoint of conductivity.

To solve the problem of conductivity, the image recording system can be improved to increase the recording speed. However, since there is a limit to the response speed of the mechanism, which turns on-and-off an energy beam, such as the spatial light modulator, the recording speed cannot be increased beyond that limit.

For instance, the response speed of the micro mirror of the existing DMD is about 50 μs. In this case, if an image of two gray levels is recorded on a recording medium whose resolution is 2 μm, the moving speed in the vertical scanning direction of the recording medium must be 40 mm/s or less. If recording is performed while moving the recording medium at that speed, it takes 15 to 20 seconds to record images in a range of length 600 mm in the vertical scanning direction.

For example, if an image of four gray levels is recorded, it becomes necessary to scan a recording medium with different energy amounts of three steps. If the image is to be recorded in the same time as the image of two gray levels, the response speed of the DMD has to be improved to 17 μs, which is about one-third of 50 μs. In addition, If a color image of 256 gray levels is to be recorded in the same time as the image of two gray levels, the response speed of the DMD must be improved to 0.2 μs, which is 1/255 of 50 μs. There is a possibility that the operating performance of DMDs will be gradually enhanced by improvements, but dramatic progress such as a 1/255 reduction in the response speed cannot always be expected.

### SUMMARY OF THE INVENTION

The present invention has been developed in view of the circumstances described above. Accordingly, it is the primary object of the present invention to provide a method and system capable of recording images at high speed without being influenced by a limit to the response speeds of the spatial light modulator (such as DMD, etc.,) and mechanisms of performing on-off control of energy.

To achieve this end, there is provided an image recording method in accordance with the present invention. In the image recording method of the present invention, binary image data representing a desired image is first generated. The on-off control of an energy beam that scans a recording medium is performed based on a value of each pixel data constituting the binary image data, to record the image on the recording medium. Then, some pixel data are selected from pixel data of the binary image data that have a first value turning on the energy beam. The first value of the some pixel data is then replaced with a second value turning off the energy beam. And the on-off control is performed based on the first or second value of each pixel data constituting binary image data obtained after the first value is replaced with the second value. In this manner, the amount of energy irradiated to a desired region on a recording medium can be reduced.

The aforementioned energy includes heat energy, etc., in addition to light energy. The aforementioned on-off control includes the on-off control of an energy beam scanning a recording medium, in addition to the on-off control of an energy source itself. The value that turns on the energy beam may be 1 and the value that turns off the energy beam may be 0, or they may be reversed. When the value turning on the energy beam is 1, the aforementioned replacement is performed by replacing 1 with 0.

According to the above-described method, irradiation energy can be reduced only in a region where pixel-value replacement is performed, and only the amount of energy irradiated to a recording medium can be adjusted without changing the intensity of the energy emitted from the energy source.

In the image recording method of the present invention, the aforementioned some pixel data are preferably selected so that an interval between irradiated positions of energy beams corresponding to pixel data not selected becomes smaller than resolution for the recording medium and smaller than a spot size of the energy beam. This is because if the irradiated positions are too away from each other, images will be distorted or lost.

The resolution of a recording medium is the minimum linewidth that can be recorded in a distinguishable state. For example, when the recordable minimum linewidth is 20 μm, the resolution of the recording medium is 20 μm. In this case, the interval smaller than the resolution of the recording medium is an interval shorter than 20 μm. The spot size of an energy beam is defined as an area where, when the energy at the center of the laser spot is 1, an energy of 1/e² or greater is irradiated. For instance, when an energy beam is circular in cross section, the spot size is the diameter. Also, when an energy beam is rectangular in cross section, the spot size is one side of the rectangle.

In the image recording method of the present invention, a plurality of selection methods are preferably stored as the method of selecting the aforementioned some pixel data, and the aforementioned some pixel data are preferably selected by a selection method selected from the plurality of selection methods. In this case, the aforementioned some pixel data can be efficiently selected.

In the image recording method of the present invention, the aforementioned image may be classified into different kinds of regions and the aforementioned some pixel data may be selected for each of the regions by a different method of selection. For example, when the aforementioned image is a wiring pattern of a printed circuit board, it is classified into a through-hole peripheral portion and a line portion, and the aforementioned some pixel data are selected by a method of selection suitable for each portion of the wiring pattern. If the on-off control of an energy beam is performed based on binary image data obtained after pixel-value replacement is performed in this manner, different patterns can be recorded with different energy amounts by a single scanning operation.

In the image recording method of the present invention, one of the aforementioned regions may be an edge region of a pattern contained in the image. For the edge region, the aforementioned some pixel data are preferably selected so that an interval between irradiated positions of energy beams corresponding to pixel data not selected becomes ½ or less of resolution for the recording medium and ½ or less of a spot size of the energy beam. Alternatively, no pixel-value replacement is performed on the edge portion. In either case, distortion of the edge region recorded can be reduced.

The aforementioned image recording method is particularly suitable for recording images on a recording medium having a structure in which different kinds of film materials different in sensitivity to the energy beam are stacked. When a predetermined amount of energy is applied to such a recording medium, a layer with higher sensitivity than sensitivity to the energy responds, but a layer with lower sensitivity does not respond. Therefore, if a method of selecting image data on which pixel-value replacement is to be performed is determined according to the sensitivity of each layer of a recording medium, different images can be respectively recorded on different layers by a single scanning operation.

Note that the image recording method of the present invention can be employed as a method of recording images on a 1-layer recording medium in which the densities of images recorded differ by irradiated energy. When such a recording medium is employed, a region where no pixel-value replacement was performed is recorded most darkly. A region where pixel-value replacement was performed is recorded more lightly as the number of pixel data replaced becomes greater.

An image recording system, constructed in accordance with the present invention, comprises image data acquisition means, beam control means, and pixel-value replacement means. The image data acquisition means is used to generate binary image data that represents a desired image. The beam control means is used to perform on-off control of an energy beam that scans a recording medium, based on a value of each pixel data constituting the binary image data. The pixel-value replacement means is used to select some pixel data from pixel data of the binary image data that have a first value turning on the energy beam, and replace the first value of the some pixel data with a second value turning off the energy beam. The beam control means performs the on-off control, based on the first or second value of each pixel data constituting binary image data obtained after the first value is replaced by the pixel-value replacement means. It is preferable that the pixel-value replacement means perform the aforementioned processes.

According to the image recording method and image recording system of the present invention, some pixel data are selected from pixel data of binary image data that have a first value turning on an energy beam, and the first value of the some pixel data is replaced with a second value turning off the energy beam. This can make irradiation energy to a desired region smaller than other regions. Therefore, images that need to be scanned a plurality of times by the above-described conventional methods can be recorded with a single scanning operation.

In addition, the single scanning operation can prevent the problem of positional shift caused when scanning is performed a plurality of times. Therefore, high-quality image recording can be achieved and a high yield rate can be obtained in the fabrication step.

### BRIEF DESCRIPTION OF THE DRAWINGS

The present invention will be described in further detail with reference to the accompanying drawings wherein:

FIG. 1 is a sectional view showing a recording medium;

FIG. 2A is a top view used to explain an exposure method;

FIG. 2B is a sectional view used to explain the exposure method;

FIG. 3 is a perspective view showing resist patterns formed after exposure and development processes;

FIG. 4 is a block diagram showing a pattern recording system;

FIG. 5 is a diagram used to explain the vector data that is output from the CAM system shown in FIG. 4;

FIG. 6 is a diagram used to explain the binary image data that is output from the raster converting section shown in FIG. 4;

FIG. 7 is a diagram showing energy distribution for laser light;

FIG. 8 is a diagram showing the relationship between the irradiated position and spot size of laser light;

FIG. 9A is a perspective view showing the distribution of energy irradiated to the recording medium (in which no pixel-value replacement is performed);

FIG. 9B is a plan view showing the distribution of energy irradiated to the recording medium (in which no pixel-value replacement is performed);

FIG. 10 is a plan view showing binary image data obtained when pixel-value replacement is performed so that the number of 1-pixel data is reduced to half;

FIG. 11A is a perspective view showing the distribution of energy irradiated to the recording medium when the pattern of the binary image data shown in FIG. 10 is recorded;

FIG. 11B is a plan view showing the distribution of energy irradiated to the recording medium when the pattern of the binary image data shown in FIG. 10 is recorded;

FIG. 12 is a plan view showing binary image data obtained when pixel-value replacement is performed so that the number of 1-pixel data is reduced to one-fourth;

FIG. 13A is a perspective view showing the distribution of energy irradiated to the recording medium when the pattern of the binary image data shown in FIG. 12 is recorded;

FIG. 13B is a plan view showing the distribution of energy irradiated to the recording medium when the pattern of the binary image data shown in FIG. 12 is recorded;

FIG. 14 is a plan view showing binary image data obtained when pixel-value replacement is performed so that the number of 1-pixel data is reduced to one-ninth;

FIG. 15A is a perspective view showing the distribution of energy irradiated to the recording medium when the pattern of the binary image data shown in FIG. 14 is recorded;

FIG. 15B is a plan view showing the distribution of energy irradiated to the recording medium when the pattern of the binary image data shown in FIG. 14 is recorded;

FIG. 16 is a diagram showing the relationship between the distance between laser spots and the spot size of laser light;

FIG. 17 is a plan view showing another example of binary image data obtained when pixel-value replacement is performed so that the number of 1-pixel data is reduced to one-ninth;

FIG. 18A is a perspective view showing the distribution of energy irradiated to the recording medium when the pattern of the binary image data shown in FIG. 17 is recorded;

FIG. 18B is a plan view showing the distribution of energy irradiated to the recording medium when the pattern of the binary image data shown in FIG. 17 is recorded;

FIG. 19 is a plan view showing binary image data obtained when pixel-value replacement is performed so that the linewidth becomes narrower than that of the example shown in FIG. 17;

FIG. 20A is a perspective view showing the distribution of energy irradiated to the recording medium when the pattern of the binary image data shown in FIG. 19 is recorded;

FIG. 20B is a plan view showing the distribution of energy irradiated to the recording medium when the pattern of the binary image data shown in FIG. 19 is recorded;

FIG. 21 is a plan view showing binary image data obtained when pixel-value replacement is performed so that the edges of the line portion are enhanced compared with the example of FIG. 17;

FIG. 22A is a perspective view showing the distribution of energy irradiated to the recording medium when the pattern of the binary image data shown in FIG. 21 is recorded;

FIG. 22B is a plan view showing the distribution of energy irradiated to the recording medium when the pattern of the binary image data shown in FIG. 21 is recorded;

FIG. 23 is a plan view showing binary image data obtained when pixel-value replacement is performed on the interior of the line portion other than the edges thereof;

FIG. 24A is a perspective view showing the distribution of energy irradiated to the recording medium when the pattern of the binary image data shown in FIG. 23 is recorded;

FIG. 24B is a plan view showing the distribution of energy irradiated to the recording medium when the pattern of the binary image data shown in FIG. 23 is recorded;

FIG. 25 is a flowchart showing how a replacement process is performed by the pixel-value replacing section;

FIG. 26 is a perspective view of the exposure processing section shown in FIG. 4;

FIG. 27 is a perspective view showing the scanner of the exposure processing section;

FIG. 28A is a plan view showing exposed regions formed on a photosensitive material;

FIG. 28B is a plan view showing an array of exposure areas;

FIG. 29 is a perspective view showing the exposure head of the exposure processing section;

FIG. 30 is a sectional view of the exposure head in a vertical scanning direction along an optical axis;

FIG. 31 is a part-enlarged view of the digital micro mirror device (DMD) shown in FIGS. 29 and 30;

FIGS. 32A and 32B are diagrams used to explain how the DMD operates; and

FIG. 33 is a block diagram showing the electrical construction of the exposure processing section.

### DESCRIPTION OF THE PREFERRED EMBODIMENTS

As a preferred embodiment of an image recording method of the present invention, a description will hereinafter be given of a pattern recording method used when recording wiring patterns on a substrate in a printed circuit board fabrication step.

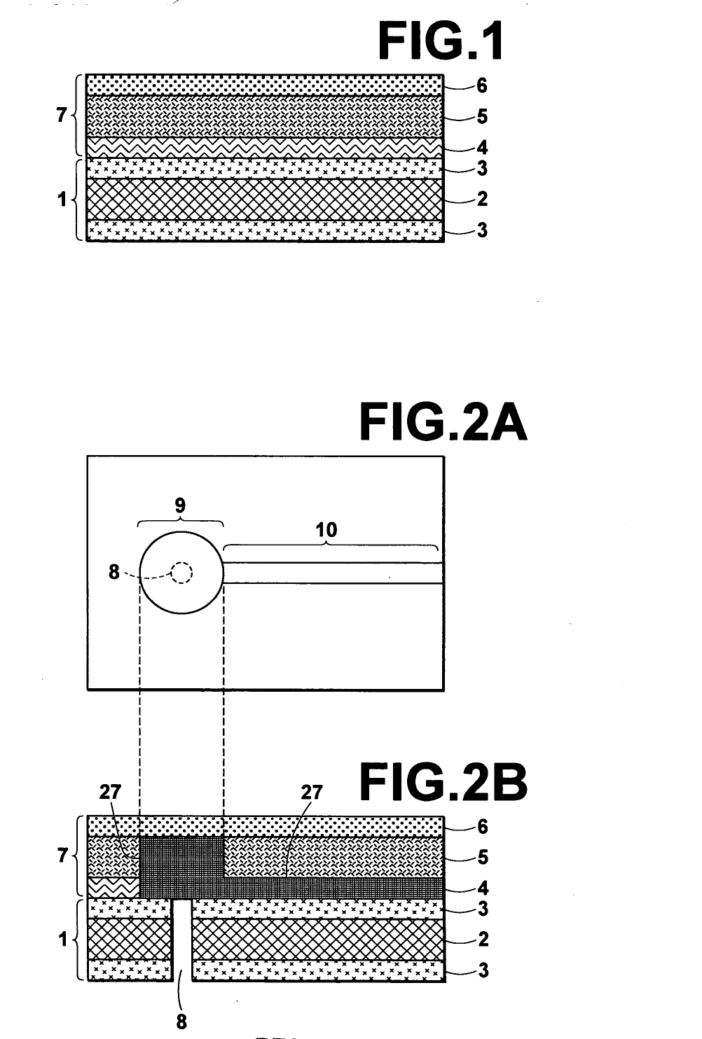

FIG. 1 shows a substrate 1 on which wiring patterns are to be formed. A resist film 7 has been stuck on the substrate 1. The substrate 1 on which the resist film 7 has been stuck is called a recording medium where necessary.

As shown in FIG. 1, the substrate 1 comprises a glass epoxy substrate material 2, and thin films of copper 3 stacked on both surfaces of the substrate material 2. The resist film 7 comprises a support layer 6, a thick-film low-photosensitive layer 5 (hereinafter referred to as a thick photosensitive layer 5) stacked on the support layer 6, and a thin-film highly-photosensitive layer 4 (hereinafter referred to as a thin photo sensitive layer 4) stacked on the thick photo sensitive layer 5. As shown in FIG. 1, the resist film 7 is stuck on the substrate 1 so that the thin photosensitive film 4 is contacted with the substrate 1.

The thin photosensitive layer 4 is constructed of a material that becomes sensitive to light when irradiated with an energy of 4 mJ/cm² or greater, and the thickness is about 5 to 10 μm. The thick photosensitive layer 5 is constructed of a material that becomes sensitive to light when irradiated with an energy of 40 mJ/cm² or greater, and the thickness is about 20 to 25 μm. The support layer 6 is formed from polyethylene terephthalate (PET) and the thickness is about 15 to 25 μm.

Note that instead of sticking the resist film 7 on the substrate 1, the thin photosensitive layer 4 and thick photosensitive layer 5 may be formed on the substrate 1 in the recited order.

FIG. 2 shows a thick pattern formed only in a portion in which a through hole 8 is formed. FIG. 2A shows a top view of the recording medium and FIG. 2B shows a sectional view of the recording medium.

A peripheral portion 9 surrounding the through hole 8 shown in FIG. 2A is irradiated with a light energy of 40 mJ/cm² or greater (40 mJ/cm²≦light energy), while a line portion 10 is irradiated with a light energy of 4 mJ/cm² or greater and less than 40 mJ/cm² (4 mJ/cm²≦light energy<40 mJ/cm²). As shown in FIG. 2B, for the peripheral portion 9 of the through hole 8, a latent image 27 is formed in both the thin photosensitive layer 4 and the thick photosensitive layer 5. For the line portion 10, a latent image 27 is formed only in the thin photosensitive layer 4.

After exposure, for the line portion 10, a resist pattern consisting of only the thin photosensitive layer 4 is formed in the development process, as shown in FIG. 3. For the through-hole peripheral portion 9, a resist pattern comprising both the thin photosensitive layer 4 and the thick photosensitive layer 5 is formed. Therefore, the resist pattern for the through-hole peripheral portion 9 can obtain sufficient mechanical strength, and damage in the etching process can be prevented.

Next, a description will be given of the means for irradiating the peripheral portion 9 with a light energy of 40 mJ/cm² or greater (40=J/cm²≦light energy), and irradiating the line portion 10 with a light energy of 4 mJ/cm² or greater and less than 40 mJ/cm² (4=J/cm²≦light energy<40 mJ/cm²).

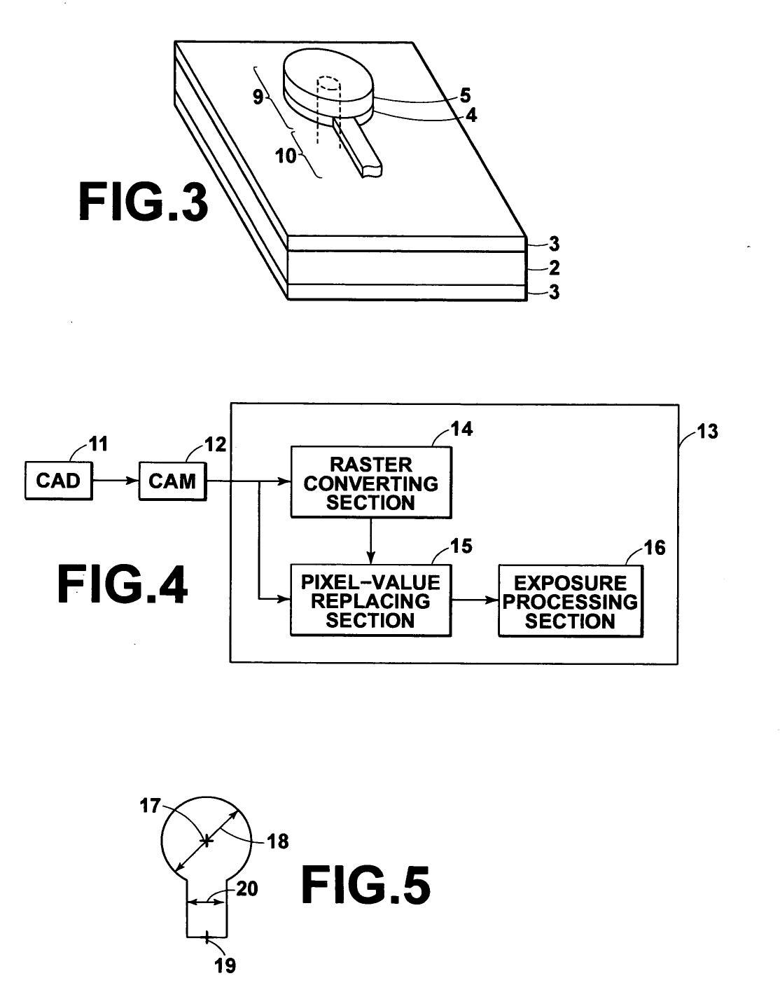

FIG. 4 shows a pattern recording system used in recording resist patterns. This pattern recording system is usually made up of a computer-aided design (CAD) system 11 and computer-aided manufacturing (CAM) system 12 used for designing patterns, and an image recorder 13 for recording patterns on a recording medium.

The CAD system 11 and CAM system 12 can be obtained by installing CAD and CAM software programs into a personal computer (PC), etc. The CAM system 12 is used to output patterns, which are to be recorded on the resist film 7 of the recording medium, as vector data. The vector data output from the CAM system 12 is input to the image recorder 13.

The image recorder 13 is equipped with a raster converting section (image-data acquiring section) 14, a pixel-value replacing section 15, and an exposure processing section 16. The raster converting section (image-data acquiring section) 14 converts the vector data input from the CAM system 12, into binary image data. The pixel-value replacing section 15 performs a pixel-value replacement process (to be described later) on the acquired binary image data. The exposure processing section 16 modulates laser light in dependence on the pixel-value replaced binary image data and outputs an exposure beam.

FIG. 5 shows the vector data that is input from the CAM system 12 to the image recorder 13. As shown in the figure, vector data, such as coordinate data representing the position 17 of the through hole 8, data representing the diameter 18 of the land of the through-hole peripheral portion 9, coordinate data representing the start or end point 19 of the line portion 10, and data representing a linewidth 20, are input from the CAM system 12 to the image recorder 13. In this embodiment, the diameter 18 of the land of the through-hole peripheral portion 9 is 0.1 to 6 mm and the linewidth 20 is 20 μm. The raster converting section 14 uses these data to generate binary image data.

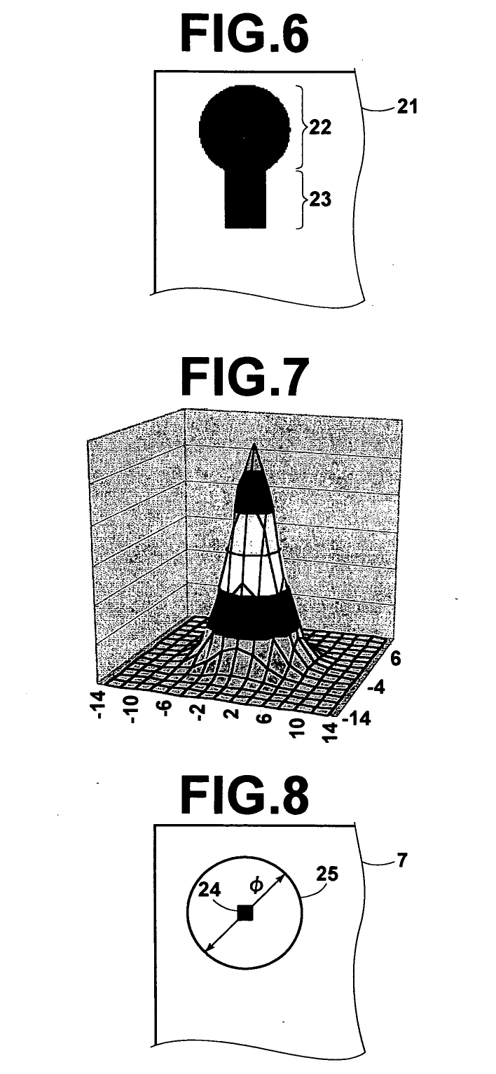

FIG. 6 shows binary image data 21 output by the raster converting section 14. The binary image data 21 comprises a first pattern image 22 to be recorded on the through-hole peripheral portion 9 and a second pattern image 23 to be recorded on the line portion 10. When the resist film 7 is negative, the raster converting section 14 outputs an image that comprises 1-pixel data (which have a value of 1) representing patterns to be recorded and 0-pixel data (which have a value of 0) representing an area other than patterns to be recorded. Such a case is shown in FIG. 6, in which 1-pixel data are shown as black and 0-pixel data are shown as white.

Conversely, when the resist film 7 is positive, the raster converting section 14 outputs an image that comprises 0-pixel data representing patterns to be recorded and 1-pixel data representing an area other than patterns to be recorded. The raster converting section 14 is preferably constructed so that one of the two methods of conversion is selected by an input signal, depending on the type of resist film used.

The binary image data 21 is processed in the pixel-value replacing section 15. Before explaining in detail the process that is performed by the pixel-value replacing section 15, a description will be given of the distribution of energy irradiated to the recording medium when laser light strikes the recording medium.

FIG. 7 shows energy distribution for laser light irradiated to one point on the recording medium. As shown in the figure, it is known that the energy distribution becomes a Gaussian distribution.

FIG. 8 shows the relationship between an area equivalent to one pixel when an image is recorded on the recording medium, and the spot size of laser light. The area of one pixel on the recording medium is represented by a first area 24. In this embodiment, the size of the first area 24 is 2 μm×2 μm. As shown in FIG. 8, laser light is irradiated to a second area 25 wider than the first area 24. In this embodiment, the spot size φ of laser light is 12 μm in diameter. The spot size φ is defined as an area where, when the energy at the center of the laser spot is 1, an energy of 1/e² or greater is irradiated.

In FIG. 8, the cross section of laser light is circular, but may be rectangular, etc. In the case of a rectangle, the spot size of laser light refers to the length of the sides of the rectangle.

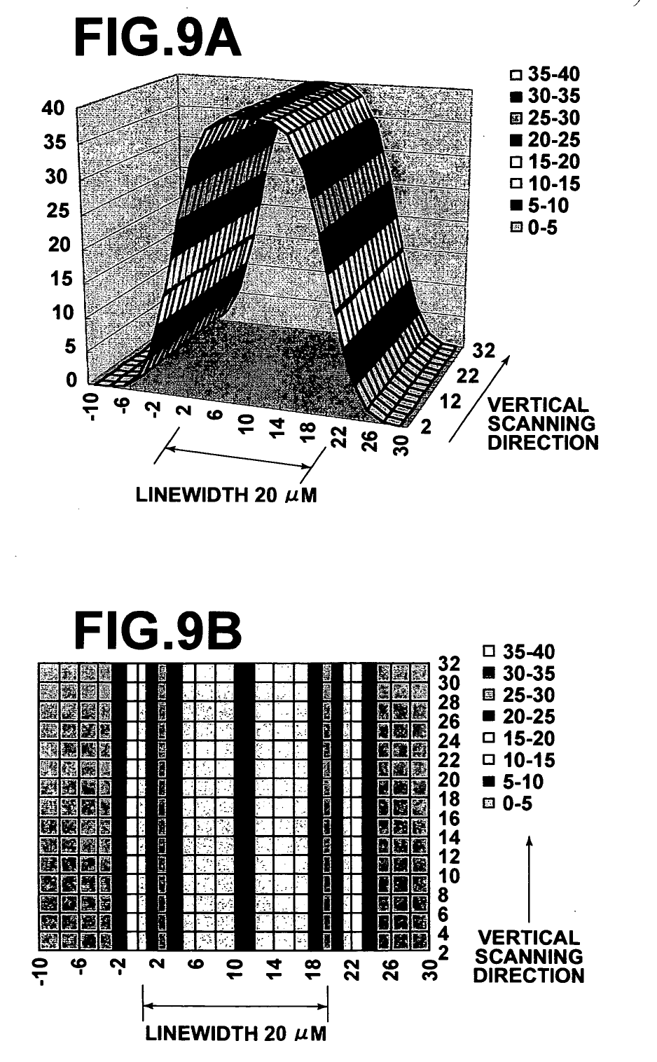

For comparison, a conventional recording method will be described. FIGS. 9A and 9B show energy distribution obtained when exposure by laser light with a predetermined intensity is performed, using the pattern image 23 of the line portion 10 of the binary image data 21 shown in FIG. 6. A perspective view of the energy distribution is shown in FIG. 9A and a plan view thereof is shown in FIG. 9B. As shown in FIG. 9A, the energy irradiated to the line portion 10 is 40 mJ/cm². This is equivalent to the energy required to expose the thick photosensitive layer 5. Therefore, in the example shown in FIGS. 9A and 9B, a thick resist pattern is formed in the line portion 10 as well as the peripheral portion 9.

Next, the process in the pixel-value replacing section 15 will be described. In order for only the thin photosensitive layer 4 to be exposed, the pixel-value replacing section 15 replaces 1-pixel data with 0-pixel data. In other words, in the line portion 10, the number of 1-pixel data is reduced. If the number of 1-pixel data is reduced, the amount of energy to be irradiated to the resist film is reduced. Therefore, even when optical scanning is performed with laser light having the same intensity as the example shown in FIGS. 9A and 9B, the thick photosensitive layer 5 in the line portion 10 is not exposed. For the through-hole peripheral portion 9, the pixel-value replacing section 15 does not perform pixel-value replacement.

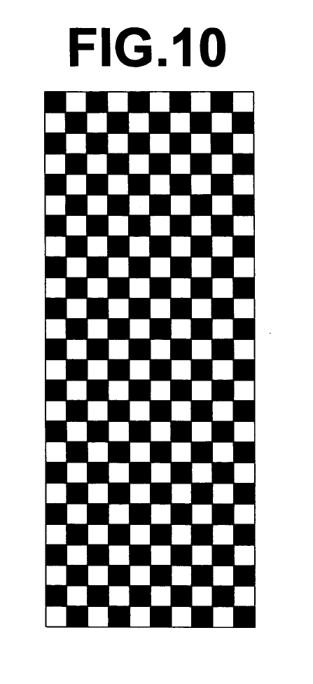

FIG. 10 shows a pattern image obtained when pixel-value replacement is performed on the pattern image 23 of the line portion of the binary image data 21 so that the number of 1-pixel data is reduced to half. That is, pixel-value replacement is performed so that a pattern image of 1-pixel data and 0-pixel data alternately arranged is obtained.

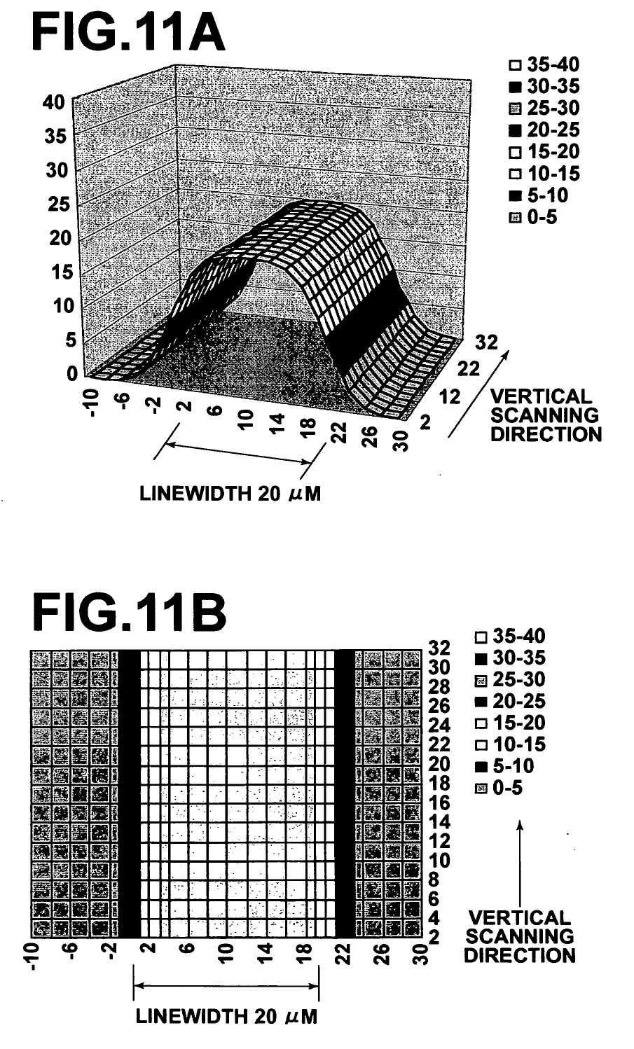

FIGS. 11A and 11B show energy distribution obtained when the pattern image shown in FIG. 10 is recorded. A perspective view of the energy distribution is shown in FIG. 11A and a plan view thereof is shown in FIG. 11B. As shown in the figures, in this example, the energy irradiated to the line portion 10 is 20 mJ/cm², which is the half of the case where no pixel-value replacement is performed. With this energy amount, a latent image is formed in the thin photosensitive layer 4, but no latent image is formed in the thick photosensitive layer 5.

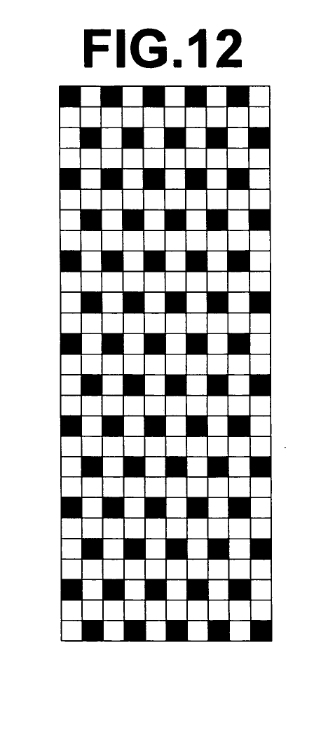

FIG. 12 shows a pattern image in which more 1-pixel data than the example of FIG. 10 are replaced with 0-pixel data. More specifically, for 2×2 pixel data (four pixel data), a 1-pixel data remains the same, but the remaining three 1-pixel data are replaced with three 0-pixel data. In this manner, the number of 1-pixel data is reduced to one-fourth of the number of pixel data for the original binary image data 21.

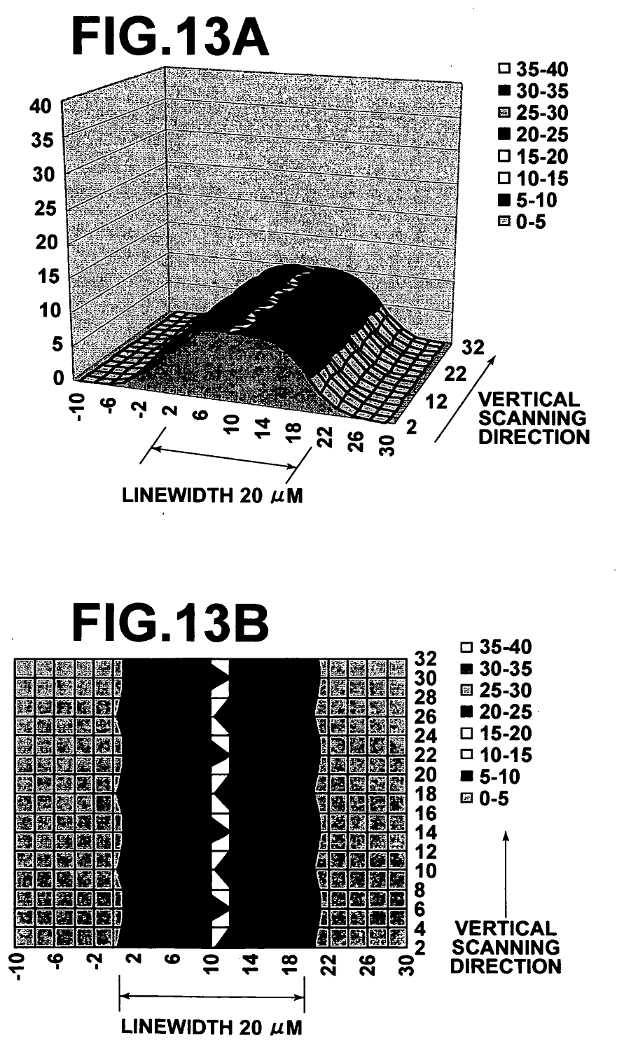

FIGS. 13A and 13B show energy distribution obtained when the pattern image shown in FIG. 12 is recorded. A perspective view of the energy distribution is shown in FIG. 13A and a plan view thereof is shown in FIG. 13B. As shown in the figures, in this example, the energy irradiated to the line portion 10 is 10 mJ/cm², which is one-fourth the case where no pixel-value replacement is performed. With this energy amount, a latent image is formed in the thin photosensitive layer 4, but no latent image is formed in the thick photosensitive layer 5.

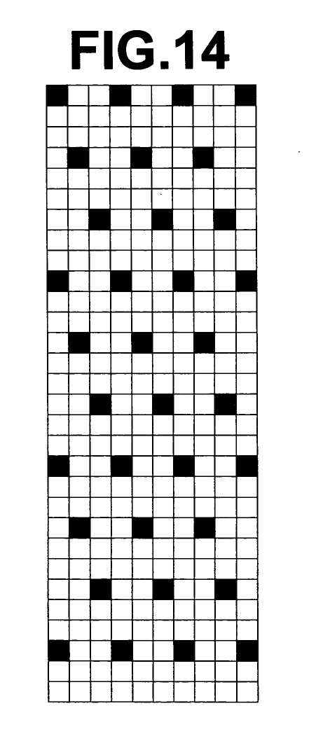

FIG. 14 shows a pattern image in which more 1-pixel data than the example of FIG. 12 are replaced with 0-pixel data. The number of 1-pixel data is reduced to one-ninth of the number of pixel data for the original binary image data 21. More specifically, for 3×3 pixel data (nine pixel data), a 1-pixel data remains the same, but the remaining eight 1-pixel data are replaced with eight 0-pixel data.

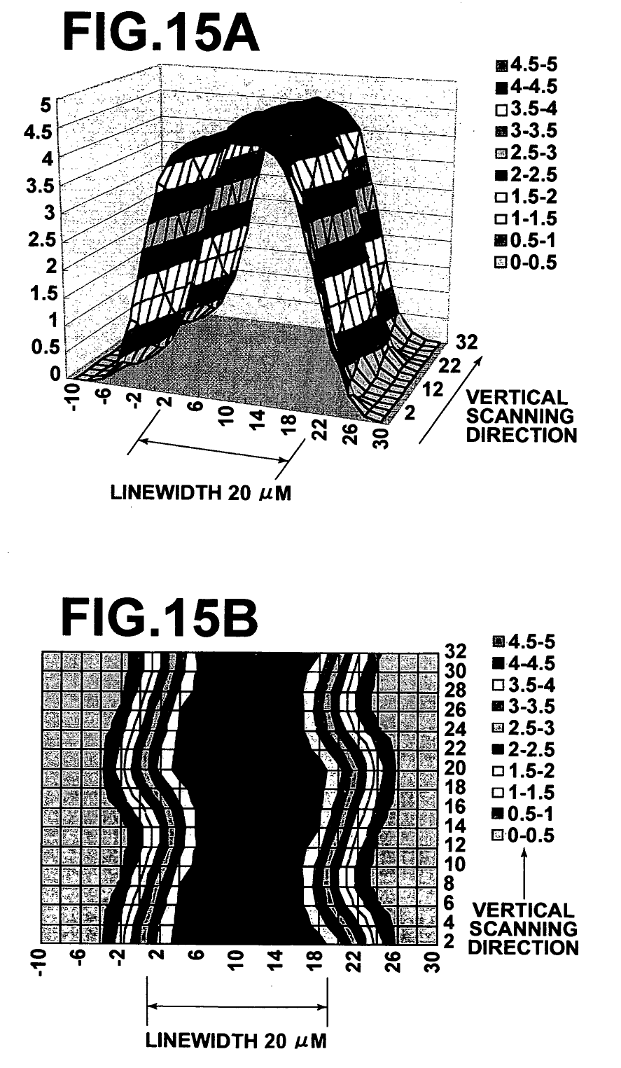

FIGS. 15A and 15B show energy distribution obtained when the pattern image shown in FIG. 14 is recorded. A perspective view of the energy distribution is shown in FIG. 15A and a plan view thereof is shown in FIG. 15B. For making it more understandable, the scale of the vertical axis in FIG. 15A is made different than that of the vertical axis of FIG. 11A or 13A. As shown in FIG. 15A, the energy irradiated to the line portion 10 is about 4.5 mJ/cm², which is one-ninth of the case where no pixel-value replacement is performed.

In the examples shown in FIGS. 10, 12, and 14, 1-pixel data are arranged zigzag in the pattern image obtained after pixel-value replacement. For that reason, as shown in FIG. 15B, the line portion 10 is shagged at its edges. That is, the edges are not straight. There is a possibility that such a shaggy land portion will change easily in impedance in circuits that process high-frequency signals and have an adverse influence on circuit operation. In addition, it cannot be said that such a shaggy land portion is preferred in appearance.

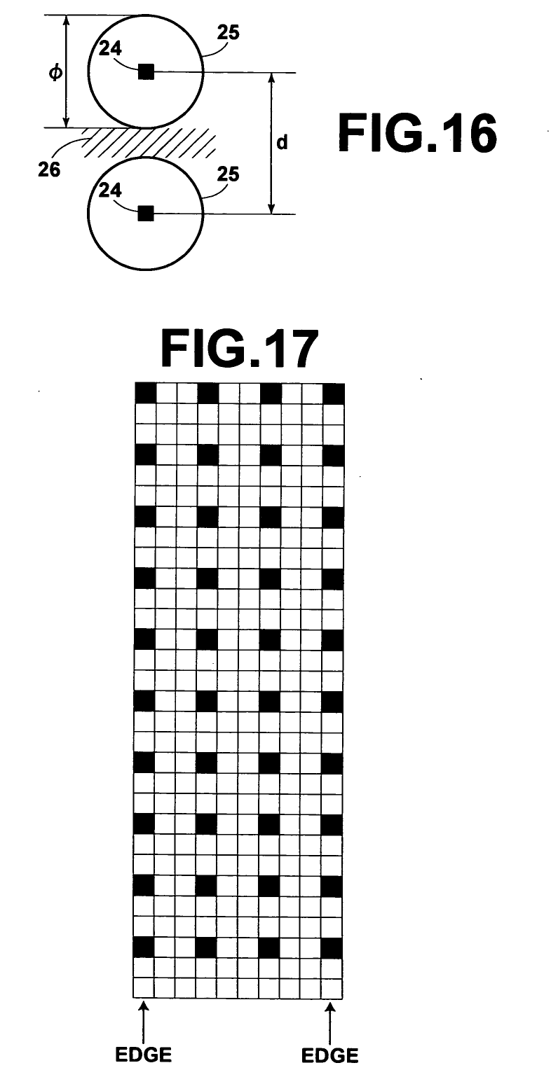

Shaggy edges will occur when the distance between two adjacent laser spots are too long. For example, if the distance d between laser spots 24 is greater than the spot size φ of laser light, as shown in FIG. 16, an area 26 where no energy is irradiated will occur at an edge and result in a shaggy edge. Also, if the distance d is greater than the resolution of a recording medium, recorded points are distinguished from each other and therefore straight edges cannot be obtained. Hence, for at least pixel data comprising an edge of the line portion 10, care must be taken that the number of 1-pixel data is not reduced unduly.

FIG. 17, as with FIG. 14, shows a pattern image in which the number of 1-pixel data is reduced to one-ninth of the number of pixel data for the original binary image data 21. As with the pattern image shown in FIG. 14, for 3×3 pixel data (nine pixel data), a 1-pixel data remains the same, but the remaining eight 1-pixel data are replaced with eight 0-pixel data. However, for pixel data constituting the edges of the line portion 10, in the example of FIG. 14, 1-pixel data and 0-pixel data are arranged in the ratio of 1:3. On the other hand, in the example of FIG. 17, 1-pixel data and 0-pixel data are arranged in the ratio of 1:9.

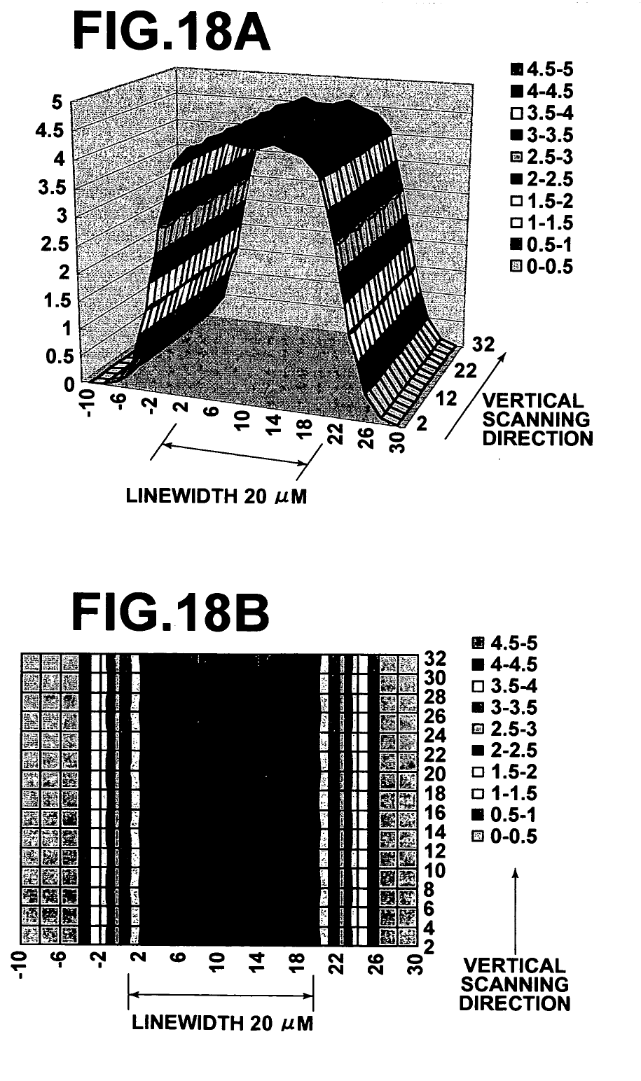

FIGS. 18A and 18B show energy distribution obtained when the pattern image shown in FIG. 17 is recorded. A perspective view of the energy distribution is shown in FIG. 18A and a plan view thereof is shown in FIG. 18B. As shown in FIG. 18A, the energy irradiated to the line portion 10 is about 4.5 mJ/cm², which is one-ninth of the case where no pixel-value replacement is performed. Compared with FIGS. 15A and 15B, it becomes clear that the edges of the line portion 10 are straight.

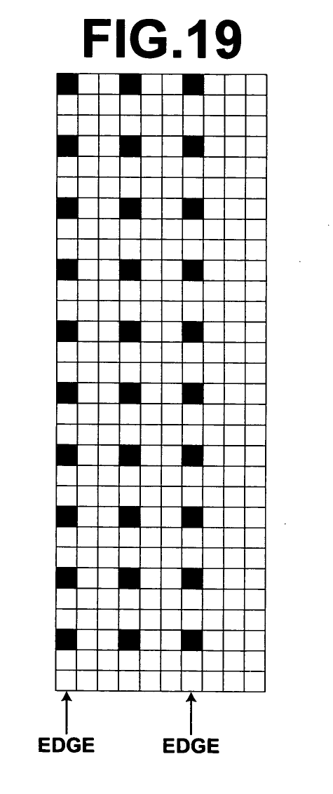

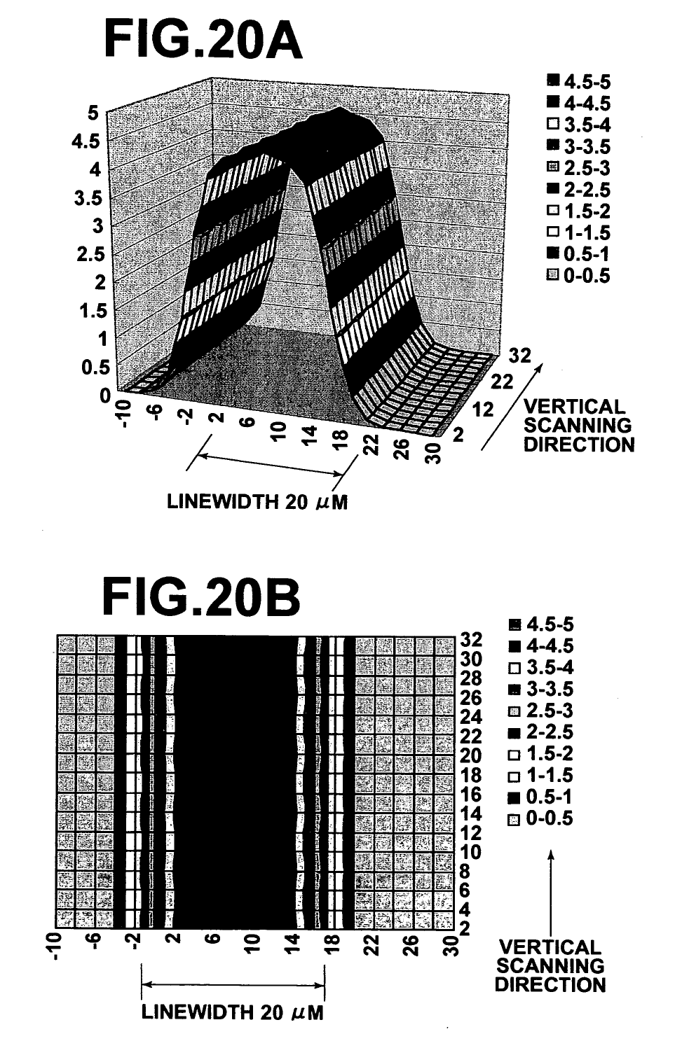

As shown in FIG. 18B, in this example, more 1-pixel data are arranged at the edges of the line portion 10, so that the linewidth becomes greater than 20 μm. For this reason, it is preferable that in the pattern image shown in FIG. 17, pixel-value replacement be further performed so that the width of the pattern image becomes narrower. FIG. 19 shows a pattern image obtained when the above-described replacement is performed. FIGS. 20A and 20B show energy distribution obtained when the pattern image shown in FIG. 19 is recorded. A perspective view of the energy distribution is shown in FIG. 20A and a plan view thereof is shown in FIG. 20B. As shown in FIG. 20B, the linewidth of the recorded line portion 10 can be made approximately 20 μm by the pixel-value replacement shown in FIG. 19.

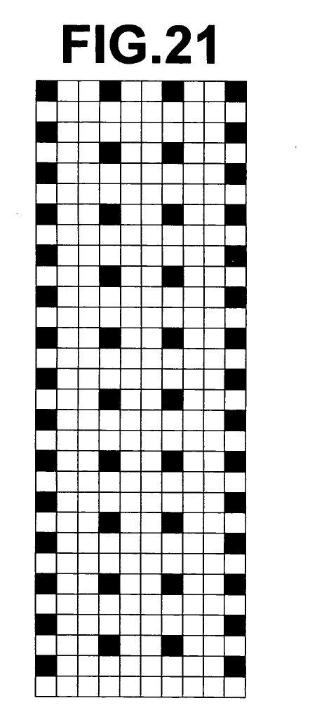

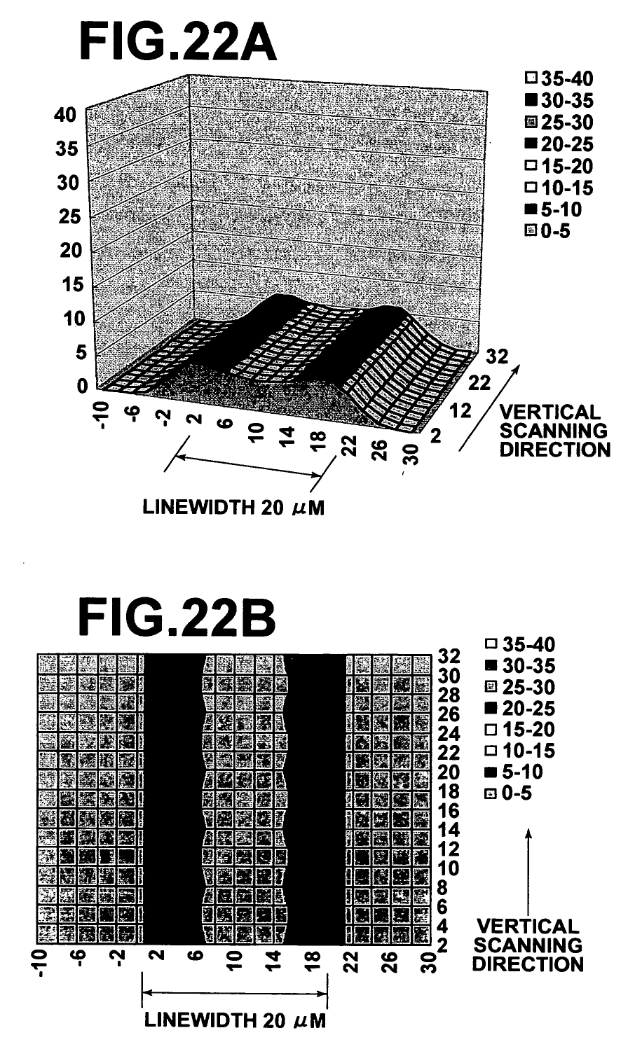

FIG. 21 shows a pattern image in which 1-pixel data and 0-pixel data are arranged in the ratio of 1:2 for pixel data constituting the edges of the line portion 10, and the same pixel-value replacement as the example of FIG. 17 is performed for the interior of the line portion 10. FIGS. 22A and 22B show energy distribution obtained when the pattern image shown in FIG. 21 is recorded. A perspective view of the energy distribution is shown in FIG. 22A and a plan view thereof is shown in FIG. 22B. As shown in the figures, high energy is irradiated to the edges of the line portion 10, so shaggy edges can be prevented.

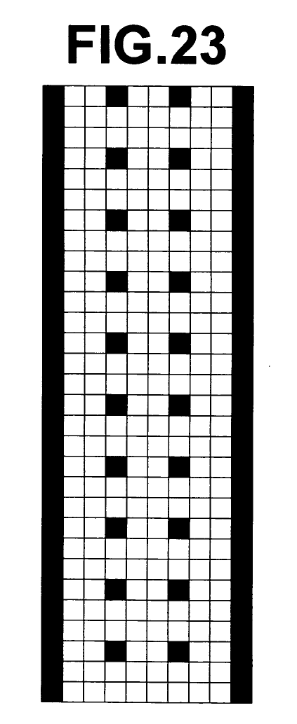

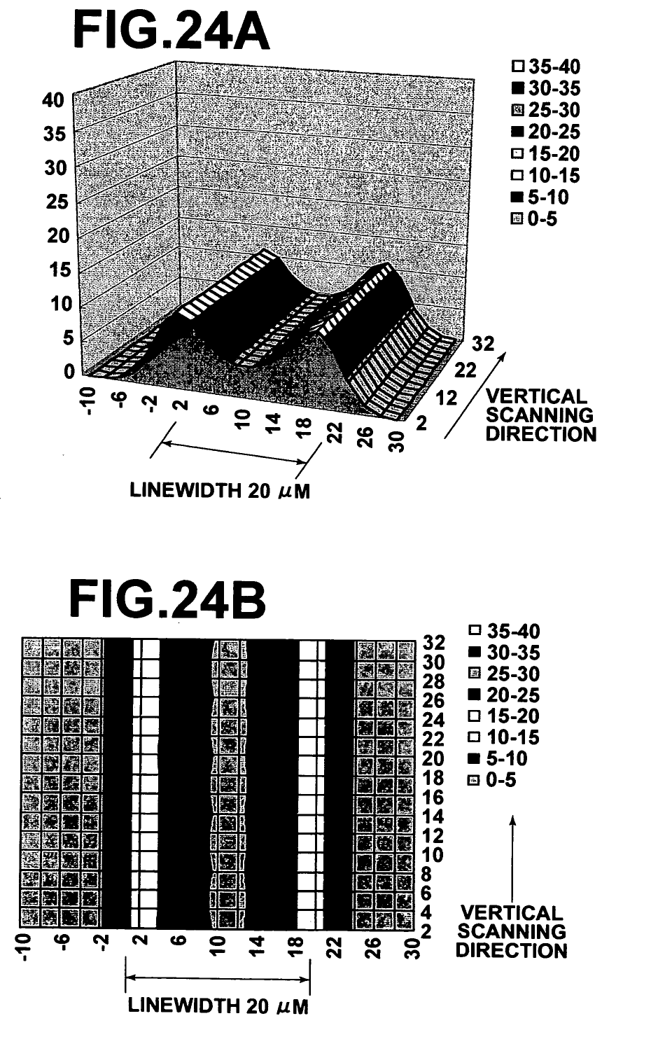

FIG. 23 shows a pattern image in which, for pixel data constituting the edges of the line portion 10, no pixel-value replacement is performed and only 1-pixel data are continuously arranged. FIGS. 24A and 24B show energy distribution obtained when the pattern image shown in FIG. 23 is recorded. A perspective view of the energy distribution is shown in FIG. 24A and a plan view thereof is shown in FIG. 24B. Compared with the example of FIG. 21, even higher energy is irradiated to the edges of the line portion 10, and the edges are enhanced.

While the pixel-value replacement by the pixel-value replacing section 15 and the advantages have been described, the pixel-value replacing section 15 may perform any one of the above-described replacement processes for all of the lines of the pattern image of the line portion 10 or may perform a different pixel-value replacement process on every line.

As previously described in FIG. 4, in this embodiment, vector data is input from the CAM system 12 to the pixel-value replacing section 15. In dependence on the input vector data, the pixel-value replacing section 15 judges how a replacement process is performed on each area of the binary image data 21, or judges that a replacement process is not performed.

For instance, if the coordinate data representing the position 17 of the through hole shown in FIG. 5 is input, the pixel-value replacing section 15 judges that the pattern of the periphery of the position 17 represented by the coordinate data is the pattern of the through-hole peripheral portion 9, and does not perform replacement of pixel values. Also, if data for the linewidth 20 is input, the pixel-value replacing section 15 judges that the pattern of the periphery is a pattern representing the line portion 10, and performs replacement of pixel values. Similarly, the pixel-value replacing section 15 can judge the edges of the line portion 10 from input vector data. This renders it possible to perform different pixel-value replacement processes on the edge region and other regions.

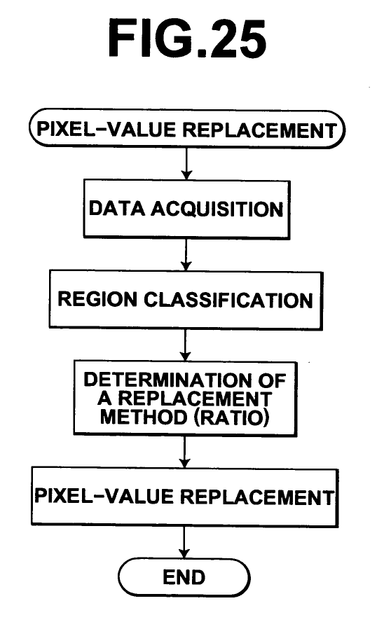

FIG. 25 shows how a replacement process is performed by the pixel-value replacing section 15. The pixel-value replacing section 15 first acquires binary image data 21 from the raster converting section 14 and vector data from the CAM system 12. Next, in dependence on the vector data, the pixel-value replacing section 15 classifies the regions contained in the binary image data 21, as the through-hole periphery, the interior region of the line portion, the edge regions of the line portion, or a region on which no data is recorded. The pixel-value replacing section 15 then judges whether pixel-value replacement is performed for each of the classified regions. When performing pixel-value replacement, the pixel-value replacing section 15 decides the number of pixel data to be replaced. Thereafter, the pixel-value replacing section 15 performs pixel-value replacement on each of the regions and generates binary image data in which a different replacement process is performed for each region.

The generated binary image data is input to the exposure processing section 16 shown in FIG. 4, and optical scanning is performed with laser light modulated in dependence on the input binary image data. Next, a description will be given of the exposure processing section 16.

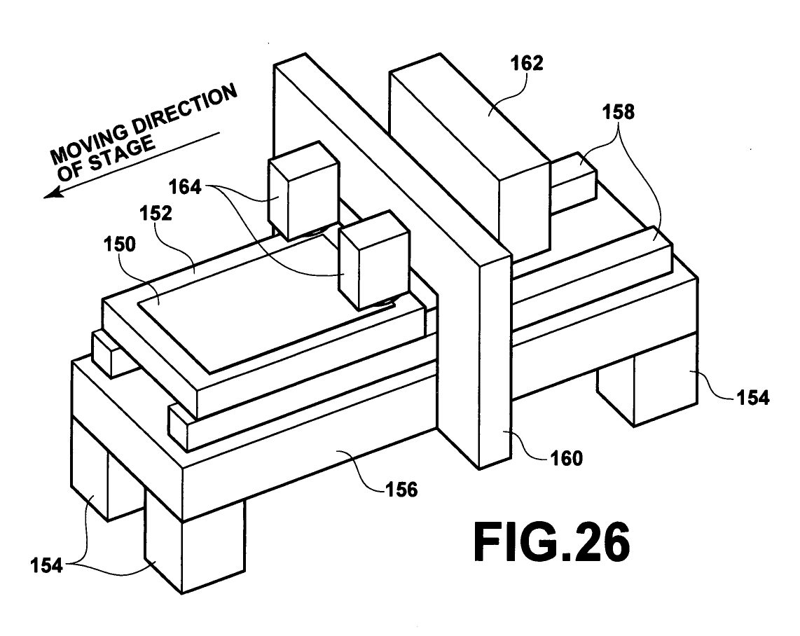

Initially, the construction of the exposure processing section 16 will be described. The exposure processing section 16 is equipped with a movable stage 152 that attracts and holds a sheet-shaped recording medium 150 on the surface thereof, as shown in FIG. 26. Two guides 158 extending along the moving direction of the stage 152 are mounted on a mounting table 156, which is in turn supported by four leg portions 154. The stage 152 is arranged so the longitudinal direction thereof becomes parallel to the moving direction of the stage 152 and is also supported by the guides 158 so it can reciprocate. Note that the exposure processing section 16 is provided with a stage driver (not shown) that drives the stage 152 (vertical scanning means) along the guides 158.

An L-shaped gate 160 is provided on the central portion of the mounting table 156 so it extends across the moving path of the stage 152. The end portions of the L-shaped gate 160 are secured to both side surfaces of the mounting table 156. A scanner 162 is disposed on one side across the gate 160, and a plurality (e.g., two) of sensors 164 are disposed on the other side. The scanner 162 and sensors 164 are attached to the gate 160 so they are positioned over the moving path of the stage 152. Note that the scanner 162 and sensors 164 are connected to a controller (not shown) that controls them.

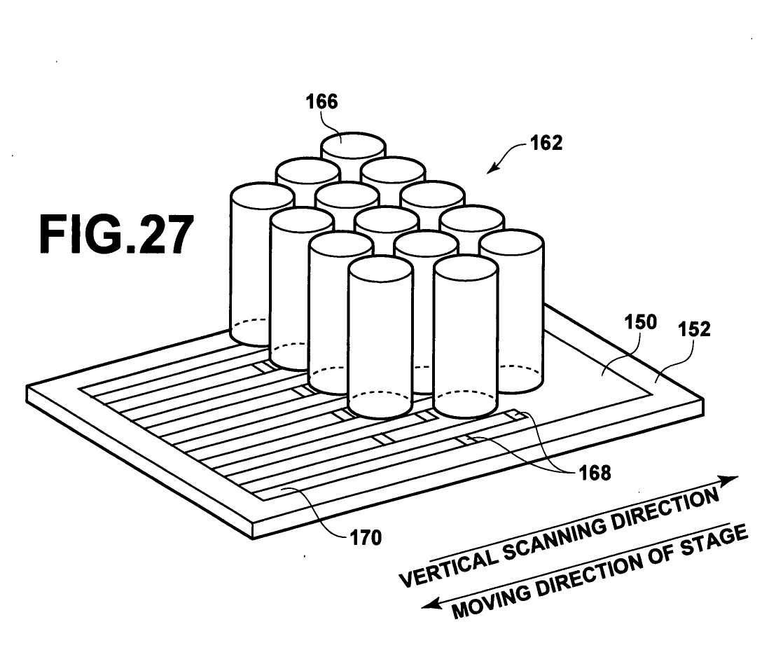

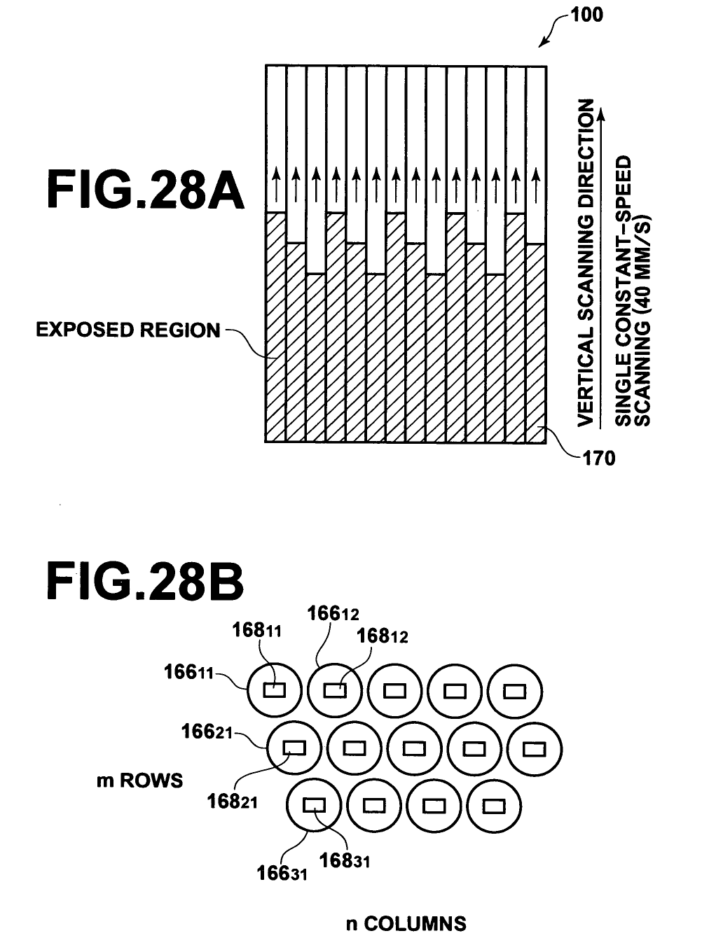

The scanner 162 is equipped with a plurality (e.g., 14) of exposure heads 166 arrayed in the form of a matrix of m rows and n columns (e.g., 3 rows and 5 columns), as shown in FIGS. 27 and 28B. In this example, with relation to the width of the recording medium 150, four exposure heads 166 are disposed in the third row. Note that an exposure head arrayed in the n^{th} column of the m^{th} row is represented by an exposure head 166ₙₘ.

An exposure area 168 by the exposure head 166 is rectangular and the short side of the exposure area 168 is arranged in a vertical scanning direction. Therefore, as the stage 152 is moved, a ribbon-like exposed region 170 is formed on the recording medium by each exposure head 166. Note that an exposure area by the exposure head arrayed in the n^{th} column of the m^{th} row is represented by an exposure area 168ₙₘ.

As shown in FIGS. 28A and 28B, the exposure heads 166 arranged in the column are shifted a predetermined space (several times the long side of the exposure area, for example, two times in this embodiment) in the row direction so that ribbon-like exposed regions 170 are arranged without a space in the direction perpendicular to the vertical scanning direction. For that reason, a space that cannot be exposed between the exposure area 168₁₁ and exposure area 168₁₂ in the first row can be exposed by the exposure area 168₂₁ in the second row and the exposure area 168₃₁ in the third row.

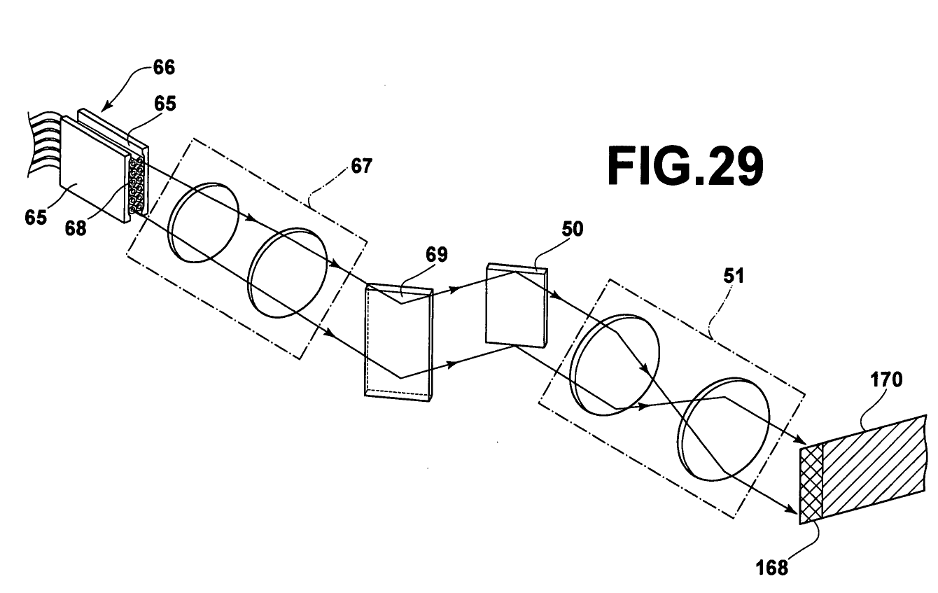

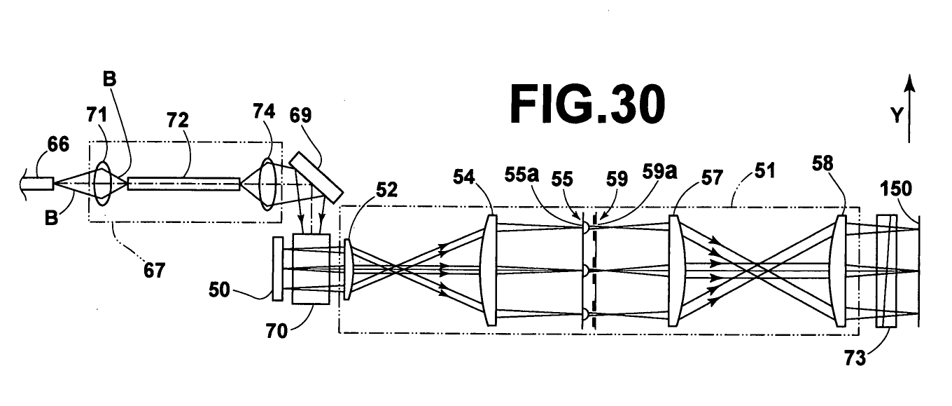

Each of the exposure heads 166₁₁ to 166ₘₙ is equipped with a digital micro mirror device (DMD) 50, which serves as a spatial light modulator for modulating an incident light beam for each pixel according to image data, as shown in FIGS. 29 and 30. The DMD 50 is connected to a controller (not shown), which is equipped with a data processing section and a mirror drive section. The data processing section of the controller generates a control signal that drives and controls each of the micro mirrors within a control region of the DMD 50 for each exposure head 166, based on input image data. The mirror drive section controls an angle of the reflecting surface of each micro mirror of the DMD 50 for each exposure head 166, based on the control signal generated by the image data processing section.

A fiber array light source 66, a lens system 67, and a mirror 69 are arranged in the recited order on the light incidence side of the DMD 50. The fiber array light source, 66 is equipped with a laser emitting section in which the light emitting ends of optical fibers are arrayed in a row along a direction corresponding to the direction of the long side of the exposure area 168. The lens system 67 corrects the laser light emitted from the fiber array light source 66 and gathers the corrected laser light onto the DMD 50. The mirror 69 reflects the laser light transmitted through the lens system 67, toward the DMD 50. Note in FIG. 29 that the construction of the lens system 67 is simplified.

As shown in FIG. 30, the lens system 67 is made up of a condenser lens 71 gathering laser light B (irradiation light) emitted from the fiber array light source 66, a rod integrator 72 inserted in the optical path of the laser light B passed through the condenser lens 71, and an image forming lens 74 arranged in front of the rod integrator 72, that is, on the side of the mirror 69. The rod integrator 72 converts the laser light emitted from the fiber array light source 66, into a nearly collimated beam of light that is uniform in intensity within the cross section. The rod integrator 72 also causes the collimated light beam to strike the DMD50.

The laser light B emitted from the lens system 67 is reflected at the mirror 69 and is irradiated to the DMD 50 through a total internal reflection (TIR) prism 70. For clarity, this TIR prism 70 is not shown in FIG. 29.

An imaging optics system 51 is disposed on the light reflection side of the DMD 50 so that the laser light B reflected at the DMD 50 is imaged onto the recording medium 150. Note in FIG. 29 that the construction of the imaging optics system 51 is simplified. As shown in FIG. 30, the imaging optics system 51 is made up of a first imaging optics system comprising lenses 52 and 54, a second imaging optics system comprising lenses 57 and 58, and a micro lens array 55 and an aperture array 59 interposed between the first and second imaging optics systems. The micro lens array 55 has a great number of micro lenses 55a corresponding to the pixels on the DMD 50. The micro lens 55a has, for example, a focal distance of 0.19 mm and a numerical aperture of 0.11. The aperture array 59 has a great number of apertures 59a corresponding to the micro lenses 55a of the micro lens array 55.

In the first imaging optics system, an image by the DMD 50 is magnified three times and is imaged on the micro lens array 55. And in the second imaging optics system, the image through the micro lens array 55 is magnified 1.67 times and is imaged onto the recording medium 150. Therefore, with the first and second imaging optics systems, an image by the DMD50 is magnified 5 times and is imaged onto the recording medium 150.

In this embodiment, a prism pair 73 is disposed between the second imaging optics system and recording medium 150. If the prism pair 73 is moved vertically in FIG. 30, an image on the recording medium 30 is brought into focus. Note in the figure that the recording medium 30 is fed in the vertical scanning direction indicated by an arrow Y.

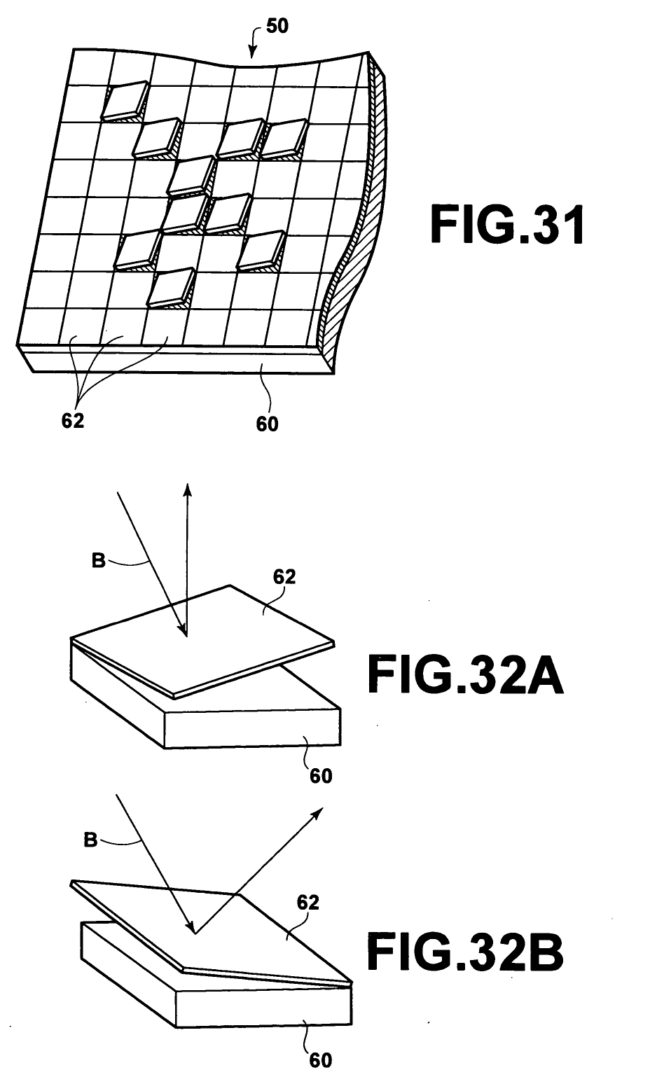

The DMD 50 has a micro mirrors 62 supported on a SRAM cell 60 by mirror support posts, as shown in FIG. 31. For example, 1024×768 micro mirrors 62 constituting pixels are arrayed in the form of a lattice. Each pixel is provided with the micro mirror 62 supported by a mirror support post on its uppermost portion. The surface of the micro mirror 62 is coated with a high-reflectance material such as aluminum, etc. Note that the reflectance of the micro mirror 62 is 90% or greater. Also, the DMD 50 has a monolithically integrated structure where a great number of micro mirrors 62 are formed on the SRAM cell 60 of the CMOS silicon gate fabricated in the fabrication of ordinary semiconductor memory, through mirror support posts including a hinge and a yoke.

If a digital signal is written to the SRAM cell 60 of the DMD 50, the micro mirror 62 supported by a support post is tilted in a range of ±α degrees (for example, ±10 degrees) to the substrate side on which the DMD 50 is arranged, with the diagonal line as the center. FIG. 32A shows the ON state of the micro mirror 62 in which the micro mirror 62 is tilted at +α degrees. FIG. 32B shows the OFF state of the micro mirror 62 in which the micro mirror 62 is tilted at −α degrees. Therefore, if the tilt of the micro mirror 62 of the DMD 50 constituting a pixel is controlled as shown in FIG. 31 in dependence on an image signal, the laser light B incident on the DMD 50 is reflected in the direction of the tilt of the micro mirror 62.

FIG. 31 enlarges part of the DMD 50 and shows the state in which the micro mirrors 62 are tilted at +α degrees or −α degrees. The on-off control of each micro mirror 62 is performed by the aforementioned controller connected to the DMD 50. Note that there is arranged a light absorbing body in a direction where the laser light B reflected at the micro mirror 62 in the OFF state travels.

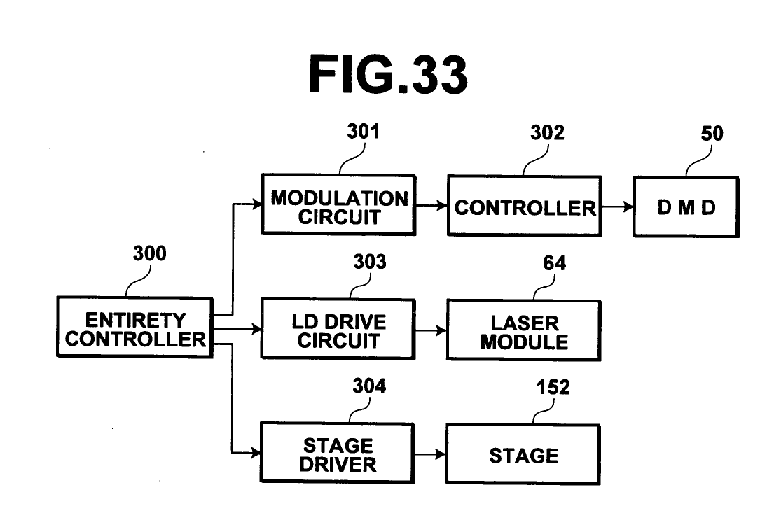

Next, the electrical construction of the exposure processing section 16 will be described with reference to FIG. 33. As shown in the figure, an entirety control section 300 is connected to a modulation circuit 301. The modulation circuit 301 acquires binary image data on which a pixel-value replacement process was performed, from the pixel-value replacing section 15 of FIG. 4. The modulation circuit 301 is connected to a controller 302 that controls the DMD 50. The entirety controlling section 300 is also connected to a laser-diode (LD) drive circuit 303 that drives a laser module 64 and to a stage driver 304 that drives the aforementioned stage 152.

Next, operation of the aforementioned exposure processing section 16 will be described. In each of the exposure heads 166 of the scanner 162, laser light emitted from each of the GaN semiconductor lasers constituting the multiplex laser light source of the fiber array light source 66 is collimated by a corresponding collimator lens. The collimated laser light is gathered by a condenser lens and is converged on the entrance surface of the core of a multi-mode optical fiber.

In this embodiment, the collimator lens and the condenser lens constitute a condenser optics system. The condenser optics system and the multi-mode optical fiber constitute a multiplex optics system. That is, the laser light gathered by the condenser lens enters the core of the multi-mode optical fiber and propagates through the optical fiber. The multiplexed laser light is emitted from an optical fiber coupled to the exit end of the multi-mode optical fiber.

In each laser module, when the coupling efficiency of laser light into a multi-mode optical fiber is 0.85 and the output of each GaN semiconductor laser is 30 mW, multiplexed laser light of output 180 mW (=30 mW×0.85×7) can be obtained for each optical fiber of a fiber array. Therefore, 14 multi-mode optical fibers can obtain laser light of 2.52 W (=0.18 W×7).

When performing image exposure, the binary image data on which the aforementioned pixel-value replacement process was performed is input from the modulation circuit 301 of FIG. 33 to the controller 302 of the DMD 50 and is temporarily stored in the frame memory.

The stage 152 held on the surface of the recording medium 150 is moved at a constant speed from the upstream side of the gate 160 to the downstream side along the guides 158. If the front end of the recording medium 150 is detected by the sensors 164 as the stage 152 is passed under the gate 160, the image data stored in the frame memory is sequentially read out a plurality of lines at a time, and the data processing section generates a control signal for each exposure head 166, based on the image data read out. In this embodiment, the size of the micro mirror corresponding to 1 pixel is 14 μm×14 μm.

If laser light is irradiated from the fiber array light source 66 to the DMD 50, the laser light reflected when a micro mirror of the DMD 50 is in the ON state is imaged onto the recording medium 150 by the first imaging optics system (52, 54) and second imaging optics system (57, 58). In this manner, the laser light emitted from the fiber array light source 66 is turned on-and-off, whereby the recording medium 150 is exposed by a number of exposure areas 168 that nearly corresponds to the number of pixels used in the DMD 50. Also, since the recording medium 150 is moved at a constant speed along with the stage 152, the recording medium 150 is scanned in the vertical scanning direction opposite to the moving direction of the stage 152 by the scanner 162, and a ribbon-like exposed region 170 is formed by each exposure head 166.

If the vertical scanning of the recording medium 150 by the scanner 162 is finished, and the rear end of the recording medium 150 is detected by the sensors 164, the stage 152 is returned by the stage driver 304 to the original point that is on the most upstream side from the gate 160 along the guides 158, and the stage 152 is again moved at a constant speed from the upstream side to the downstream side.

The operation of the exposure processing section 16 has been described above. In this embodiment, the light source provided in the exposure processing section 16 is a GaN semiconductor laser, as described previously. The wavelength of laser light emitted by a GaN semiconductor laser is 350 to 450 nm, but when the above-described two-layer resist film is used as a medium for recording images, it is preferable that the wavelength of laser light be 400 to 415 nm. Thus, it is preferable that the wavelength of laser light be selected according to the wavelength sensitivity of a recording medium used.

The exposure processing section 16 may be equipped with different kinds of light sources so that light of wavelength 300 to 10600 nm can be selected as irradiation light. The light source of the exposure processing section 16 may employ a solid laser, a gas laser, etc., in addition to a semiconductor laser diode. Specific examples are a semiconductor laser diode of wavelength about 650 nm, a combination of a YAG laser of wavelength about 532 nm and SHG, a combination of a YAG laser of wavelength about 355 nm and SHG, a combination of a YLF laser of wavelength about 355 nm and SHG, a combination of a YAG laser of wavelength about 266 nm and SHG, an excimer laser of wavelength about 248 nm, an excimer laser of wavelength about 193 nm, a CO₂ laser of wavelength about 10600 nm, etc.

According to the image recording method and system of this embodiment, as described above, the energy irradiated to the recording medium changes, depending on how a pixel-value replacement process is performed for each region in binary image data. Therefore, different amounts of energy can be recorded with a single scanning. That is, the exposure (formation of latent images) shown in FIG. 2A can be performed with a single scanning. This means that the time needed for image recording becomes one-half or less, compared with conventional image recording methods.

Also, when scanning is performed a plurality of times, like a conventional method, a newly recorded pattern is sometimes shifted from previously recorded patterns. However, in this embodiment, all patterns are recorded with a single scanning, so the problem of positional shift will not arise. Thus, it is clear that the above-described method and system are advantageous in productivity and quality.

In the above-described embodiment, while images are recorded on a resist film comprising two different kinds of photosensitive materials (thin photosensitive layer 4 and thick photosensitive layer 5), the resist film may consist of three or more photosensitive materials different in sensitivity.

For example, a resist film comprising four photosensitive materials different in sensitivity is stuck on a substrate, and binary image data output from the raster converting section is classified into five kinds of regions. In one of the five regions, all pixel data have a value of 0. Among regions that have 1-pixel data, in a first region 1-pixel data are not replaced. In a second region, 1-pixel data are replaced in the ratio of 1:2 so that the number of 1-pixel data becomes ½. In a third region, 1-pixel data are replaced in the ratio of 3:4 so that the number of 1-pixel data becomes ¼. In a fourth region, 1-pixel data are replaced in the ratio of 8:9 so that the number of 1-pixel data becomes 1/9. Thus, based on the binary image data in which a different pixel-value replacement process was performed on each region, laser light is modulated and exposure is performed.

In such a form, that is, in the case where a conventional method needs to perform scanning three times, the time needed for image recording can be further shortened, compared with the two-layer recording medium shown in the above-described embodiment. In addition, if the number of scanning operations is increased, the problem of positional shift will arise easily. Therefore, the advantage that is obtained in that point is great.

In the above-described embodiment, although images are recorded by light energy, the present invention is characterized in that the aforementioned pixel-value replacement process is performed on binary image data employed in the ON/OFF control of an energy beam scanning a recording medium. Therefore, the present invention is also applicable to systems that record images by employing heat energy (a thermal head, etc.). The type of energy and construction of energy irradiation system are not limited to the above-described embodiment. Also, the present invention is not to be limited to the details given herein, but may be modified within the scope of the invention hereinafter claimed.

1. An image recording method comprising the steps of:
generating binary image data that represents a desired image;
performing on-off control of an energy beam that scans a recording medium, based on a value of each pixel data constituting said binary image data, to record said image on said recording medium; and
selecting some pixel data from pixel data of said binary image data that have a first value turning on said energy beam, and replacing the first value of said some pixel data with a second value turning off said energy beam;
wherein said on-off control is performed based on the first or second value of each pixel data constituting binary image data obtained after said first value is replaced with said second value.

2. The image recording method as set forth in claim 1, wherein said some pixel data are selected so that an interval between irradiated positions of energy beams corresponding to pixel data not selected becomes smaller than resolution for said recording medium and smaller than a spot size of said energy beam.

3. The image recording method as set forth in claim 1, wherein
a plurality of selection methods are previously stored as the method of selecting said some pixel data, and
said some pixel data are selected by a selection method selected from said plurality of selection methods.

4. The image recording method as set forth in claim 3, wherein said image is classified into different kinds of regions and said some pixel data are selected for each of said regions by a different selection method.

5. The image recording method as set forth in claim 4, wherein
one of said regions is an edge region of a pattern contained in said image, and
for said edge region, said some pixel data are selected so that an interval between irradiated positions of energy beams corresponding to pixel data not selected becomes ½ or less of resolution for said recording medium and ½ or less of a spot size of said energy beam.

6. The image recording method as set forth in claim 4, wherein
one of said regions is an edge region of a pattern contained in said image, and
for said edge region, said first value is not replaced with said second value.

7. The image recording method as set forth in claim 1, wherein
said energy beam comprises a laser light beam, and
on-off control of said laser light beam is performed by a spatial light modulator.

8. The image recording method as set forth in claim 1, wherein said recording medium has a structure in which different kinds of film materials different in sensitivity to said energy beam are stacked.

9. An image recording system comprising:
image data acquisition means for generating binary image data that represents a desired image;
beam control means for performing on-off control of an energy beam that scans a recording medium, based on a value of each pixel data constituting said binary image data; and
pixel-value replacement means for selecting some pixel data from pixel data of said binary image data that have a first value turning on said energy beam, and replacing the first value of said some pixel data with a second value turning off said energy beam;
wherein said beam control means performs said on-off control, based on the first or second value of each pixel data constituting binary image data obtained after said first value is replaced by said pixel-value replacement means.

10. The image recording system as set forth in claim 9, wherein said pixel-value replacement means selects said some pixel data so that an interval between irradiated positions of energy beams corresponding to pixel data not selected becomes smaller than resolution for said recording medium and smaller than a spot size of said energy beam.

11. The image recording system as set forth in claim 9, wherein said pixel-value replacement means previously stores a plurality of selection methods as the method of selecting said some pixel data, and selects said some pixel data by a selection method selected from said plurality of selection methods.

12. The image recording system as set forth in claim 11, wherein said pixel-value replacement means classifies said image into different kinds of regions and selects said some pixel data for each of said regions by a different selection method.

13. The image recording system as set forth in claim 12, wherein
one of said regions is an edge region of a pattern contained in said image, and
for said edge region, said pixel-value replacement means selects said some pixel data so that an interval between irradiated positions of energy beams corresponding to pixel data not selected becomes ½ or less of resolution for said recording medium and ½ or less of a spot size of said energy beam.

14. The image recording system as set forth in claim 12, wherein
one of said regions is an edge region of a pattern contained in said image, and
for said edge region, said pixel-value replacement means does not replace said first value.

15. The image recording system as set forth in claim 9, wherein
said energy beam comprises a laser light beam, and
said beam control means performs on-off control of said laser light beam by a spatial light modulator.
